(19) United States
(12) Patent Application Publication
(10) Pub. No.: US 2026/0037207 A1
(43) Pub. Date: Feb. 5, 2026

(54) CONTENT SHARING METHOD AND APPARATUS, DEVICE, STORAGE MEDIUM, AND COMPUTER PROGRAM PRODUCT

(71) Applicant: Tencent Technology (Shenzhen) Company Limited, Shenzhen (CN)

(72) Inventor: Yi ZHU, Shenzhen (CN)

(21) Appl. No.: 19/351,081

(22) Filed: Oct. 6, 2025

Related U.S. Application Data
(63) Continuation of application No. PCT/CN2024/104886, filed on Jul. 11, 2024.

(30) Foreign Application Priority Data
Sep. 20, 2023 (CN) 202311221928.8

(51) Int. Cl. G06F 3/14

(52) U.S. Cl. CPC G06F 3/1454

(57) ABSTRACT

This application relates to a method for sharing content in an online meeting performed by a server. The method includes: in response to a content sharing request initiated by a meeting member participating in an online meeting, adding the meeting member designated to perform content sharing to a waiting space; forwarding the content sharing request to a host terminal of the meeting wherein the host terminal is configured to determine whether or not to grant the content sharing request; and in response to an activation instruction transmitted by the host terminal, determining, among meeting members in the waiting space, a meeting member indicated by the activation instruction, and transmitting to-be-shared content of the meeting member indicated by the activation instruction to participant terminals used by other meeting members participating in the meeting.

### CROSS-REFERENCE TO RELATED APPLICATIONS

This application is a continuation application of PCT Patent Application No. PCT/CN2024/104886, entitled “CONTENT SHARING METHOD AND APPARATUS, DEVICE, STORAGE MEDIUM, AND COMPUTER PROGRAM PRODUCT” filed on Jul. 11, 2024, which claims priority to Chinese Patent Application No. 2023112219288, entitled “CONTENT SHARING METHOD AND APPARATUS, DEVICE, STORAGE MEDIUM, AND COMPUTER PROGRAM PRODUCT” filed with the China National Intellectual Property Administration on Sep. 20, 2023, all of which are incorporated herein by reference in their entirety.

### FIELD OF THE TECHNOLOGY

This application relates to the field of computer technologies, and in particular, to a content sharing method and apparatus, a computer device, a storage medium, and a computer program product.

### BACKGROUND OF THE DISCLOSURE

An online meeting is a meeting conducted over a network. A participant can use a screen-sharing or screen-recording function of an online meeting platform to present a PowerPoint (PPT, presentation software) slide, a Web page, or another meeting material for discussion and decision-making about a related event by other participants in the online meeting. This effectively solves the problem of geographical barriers between the meeting members.

At present, only one participant is allowed to share a screen in an online meeting. When the participant is sharing the screen, if another participant needs to share a screen, the participant who is currently sharing the screen needs to terminate sharing, and then the another participant can start screen sharing. In this way, switching of the shared screens is achieved.

If a plurality of participants need to share screens, a screen-sharing operation needs to be repeated among participants for many times. The switching operation in this manner is relatively complex and time-consuming, resulting in relatively low content sharing efficiency of an online meeting.

### SUMMARY

This application provides a content sharing method and apparatus, a computer device, a storage medium, and a computer program product.

In an aspect, this application provides a method for sharing content in an online meeting performed by a computer device. The method includes:
in response to a content sharing request initiated by a meeting member participating in an online meeting, adding the meeting member designated to perform content sharing to a waiting space;
forwarding the content sharing request to a host terminal of the meeting wherein the host terminal is configured to determine whether or not to grant the content sharing request; and
in response to an activation instruction transmitted by the host terminal, determining, among meeting members in the waiting space, a meeting member indicated by the activation instruction, and transmitting to-be-shared content of the meeting member indicated by the activation instruction to participant terminals used by other meeting members participating in the meeting.

In another aspect, this application further provides a computer device. The computer device includes a memory and a processor, the memory has a computer program stored therein, and the processor, when executing the computer program, causing the computer device to implement operations of the foregoing content sharing method.

In another aspect, this application further provides a non-transitory computer-readable storage medium. The computer-readable storage medium has a computer program stored therein, and the computer program, when executed by a processor of a computer device, causing the computer device to implement operations of the foregoing content sharing method.

Details of one or more embodiments of this application will be provided in the accompanying drawings and descriptions below. Other features, objectives, and advantages of this application become apparent from the specification, the drawings, and the claims.

### BRIEF DESCRIPTION OF THE DRAWINGS

To more clearly illustrate technical solutions in embodiments of this application or in the conventional technology, the accompanying drawings required for the description of the embodiments or in the conventional technology will be briefly introduced below. Apparently, the accompanying drawings in the following description are only the embodiments of this application, and a person of ordinary skill in the art may derive other drawings from the disclosed drawings without making creative efforts.

FIG. 1 is a diagram of an application environment of a content sharing method according to an embodiment.

FIG. 2 is a schematic flowchart of a content sharing method according to an embodiment.

FIG. 3 is a diagram of status of a meeting member according to an embodiment.

FIG. 4 is a schematic diagram of an enabling control configured for enabling a waiting space on a host terminal according to an embodiment;

FIG. 5 is a schematic flowchart of a content sharing method according to another embodiment.

FIG. 6 is a schematic diagram of a display interface of a host terminal when a waiting space is not enabled according to an embodiment.

FIG. 7 is a schematic diagram of a display interface of a host terminal after a waiting space is enabled according to an embodiment.

FIG. 8 is a schematic diagram of a meeting member and activation status of each meeting member in a waiting space displayed by a host terminal according to an embodiment.

FIG. 9 is a schematic diagram of a to-be-activated state of a meeting member who enters a waiting space and who is designated to perform content sharing that is displayed by a participant terminal according to an embodiment.

FIG. 10 is a schematic diagram of a sharing guide area of a host terminal according to an embodiment.

FIG. 11 is a schematic diagram of a sharing guide area of a host terminal according to another embodiment.

FIG. 12 is a schematic diagram of a removal control within a preset proximity range according to an embodiment.

FIG. 13 is a schematic diagram of first prompt information according to an embodiment.

FIG. 14 is a schematic diagram of second prompt information according to an embodiment.

FIG. 15 is a schematic diagram of operational logic of a host terminal according to an embodiment.

FIG. 16 is a schematic flowchart of a content sharing method according to another embodiment.

FIG. 17 is a schematic diagram of control logic for sharing content by a participant terminal according to an embodiment.

FIG. 18 is a schematic diagram of third prompt information according to an embodiment.

FIG. 19 is a schematic diagram of fourth prompt information according to an embodiment.

FIG. 20 is a schematic diagram of fifth prompt information according to an embodiment.

FIG. 21 is a detailed time sequence diagram of a content sharing method according to an embodiment.

FIG. 22 is a structural block diagram of a content sharing apparatus according to an embodiment.

FIG. 23 is a structural block diagram of a content sharing apparatus according to another embodiment.

FIG. 24 is a structural block diagram of a content sharing apparatus according to another embodiment.

FIG. 25 is a diagram of an internal structure of a computer device according to an embodiment.

FIG. 26 is a diagram of an internal structure of a computer device according to another embodiment.

### DESCRIPTION OF EMBODIMENTS

Technical solutions in embodiments of this application will be clearly and completely described below with reference to the accompanying drawings of the embodiments of this application. Apparently, the described embodiments are merely some embodiments rather than all embodiments of this application. All other embodiments derived by a person of ordinary skill in the art based on the embodiments in this application without creative efforts fall within the scope of protection of this application.

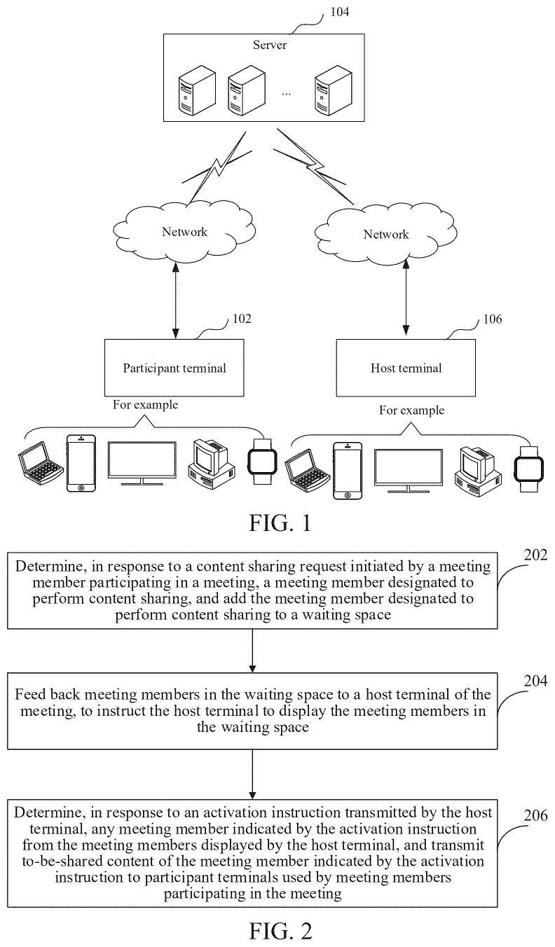

A content sharing method provided in the embodiments of this application may be applied to an application environment shown in FIG. 1. A participant terminal 102 transmits a content sharing request to a server 104. The server 104 determines, in response to the content sharing request initiated by a meeting member participating in a meeting, a meeting member designated to perform content sharing, and adds the meeting member designated to perform content sharing to a waiting space. The server 104 returns meeting members in the waiting space to a host terminal 106 of the meeting, to instruct the host terminal 106 to display the meeting members in the waiting space. The host terminal 106 transmits an activation instruction for any meeting member in the displayed meeting members. The server 104 transmits, in response to the activation instruction that is transmitted by the host terminal 106 and is configured for indicating any meeting member in the displayed meeting member, to-be-shared content of the meeting member indicated by the activation instruction to participant terminals used by meeting members participating in the meeting.

The participant terminal 102 and the host terminal 106 may be, but are not limited to, various desktop computers, notebook computers, smartphones, tablet computers, and Internet of Things devices. The Internet of Things devices may be smart televisions or the like. The server 104 may be an independent physical server, or may be a server cluster or distributed system composed of a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. A user terminal includes, but is not limited to, a mobile phone, a computer, an intelligent speech interaction device, an intelligent household appliance, an on-board terminal, and an aircraft. The terminal and the server may be connected directly or indirectly by using a wired or wireless communication protocol. This is not limited in this application.

In an embodiment, as shown in FIG. 2, a content sharing method is provided. A description is made by using an example in which the method is applied to the server shown in FIG. 1, and the method includes the following operations.

Operation 202: Determine, in response to a content sharing request initiated by a meeting member participating in a meeting, a meeting member designated to perform content sharing, and add the meeting member designated to perform content sharing to a waiting space.

The meeting refers to a multi-person online meeting that achieves data sharing among a plurality of users in different locations through the network technology. The meeting includes a plurality of meeting members and one host member. A terminal of the host member is referred to as a host terminal, a terminal of the meeting member is referred to as a participant terminal, and different meeting members use different terminals.

The waiting space may be understood as a virtual waiting room, which is configured for caching data. For example, the waiting space may be specifically a cache space on the server and/or the host terminal, a waiting queue, or the like. In some scenarios, data cached in the waiting space may have a particular sequence.

The host terminal is configured to set permission of the meeting member. For example, the host terminal can control entry of a meeting member to the waiting space or removal of a meeting member from the waiting space, enabling or disabling of the waiting space, activation of a meeting member in the waiting space, or the like. Status of a meeting member who does not enter the waiting space is an unshared state, and activation status of a meeting member who enters the waiting space includes a to-be-activated state and an activated state. The to-be-activated state refers to a state where a meeting member enters the waiting space but has not performed content sharing. After the meeting member enters the waiting space, initial status is the to-be-activated state. The activated state refers to a state where a meeting member enters the waiting space and is performing content sharing. For example, the host terminal controls the waiting space to be enabled, and controls a meeting member in an unshared state to enter the waiting space. In this case, status of the meeting member who enters the waiting space is switched from the unshared state to a to-be-activated state. After the host terminal activates the meeting member, the status of the meeting member is switched from the to-be-activated state to an activated state.

The participant terminal is configured to initiate a content sharing request. After the content sharing request passes a review of the host terminal, to-be-shared content of the participant terminal is transmitted to participant terminals used by other meeting members participating in the meeting. The meeting member designated to perform content sharing refers to a meeting member logging in to a participant terminal.

The content sharing request is initiated by a participant terminal, and is configured for requesting the server to share to-be-shared content of the meeting member transmitting the content sharing request with other meeting members in the meeting. The to-be-shared content refers to shared screen data of a meeting material that is being presented by the meeting member transmitting the content sharing request. The meeting material may be a PowerPoint (PPT) slide, a Web page, a text material, a video material, or the like.

In some embodiments, the content sharing request may carry to-be-shared content and member information of the meeting member who initiates the content sharing request. The member information may be specifically information, such as a name, an avatar, or a network address, of the meeting member.

In some embodiments, the meeting member designated to perform content sharing may be the meeting member who initiates the content sharing request. In some other embodiments, the meeting member designated to perform content sharing may be a meeting member who initiates a content sharing request and who passes a review.

Specifically, the server receives content sharing requests transmitted by a plurality of meeting members in the meeting, the server reviews the content sharing requests, and after the content sharing request passes the review, the server adds the meeting member designated to perform content sharing to the waiting space. Alternatively, the server forwards the received content sharing requests to the host terminal, the host terminal reviews the content sharing requests, the server receives review results fed back by the host terminal, and after the content sharing requests pass the review, the server adds the meeting members designated to perform content sharing to the waiting space.

In some embodiments, for the first meeting member who initiates a content sharing request, the server directly adds the meeting member to the waiting space. For the second or subsequent meeting members who initiate content sharing requests, the server or the host terminal reviews the content sharing requests, and when the content sharing request passes the review, the server adds the meeting member designated to perform content sharing to the waiting space.

Operation 204: Return meeting members in the waiting space to a host terminal of the meeting, to instruct the host terminal to display the meeting members in the waiting space.

Specifically, the server obtains activation status, to-be-shared content, and member information of each meeting member in the waiting space, and returns the obtained activation status, to-be-shared content, and member information to the host terminal of the meeting, to instruct the host terminal to display the activation status, to-be-shared content, and member information of the meeting members in the waiting space on an interface of the host terminal.

Operation 206: Determine, in response to an activation instruction transmitted by the host terminal, any meeting member indicated by the activation instruction from the meeting members displayed by the host terminal, and transmit to-be-shared content of the meeting member indicated by the activation instruction to participant terminals used by meeting members participating in the meeting.

The activation instruction is generated according to an activation operation of the host terminal for any to-be-activated meeting member in the waiting space, and is configured for instructing the server to switch the status of the to-be-activated meeting member indicated by the activation instruction to an activated state, and transmit to-be-shared content of the meeting member to the participant terminals used by the meeting members participating in the meeting, to achieve content sharing.

In some embodiments, the host terminal can activate any to-be-activated meeting member in the waiting space, but only one activated meeting member can exist in the waiting space at the same moment, and other meeting members in the waiting space are all in the to-be-activated state.

In some embodiments, the activation operation may be that the host terminal triggers an activation control configured for switching any to-be-activated meeting member in the waiting space.

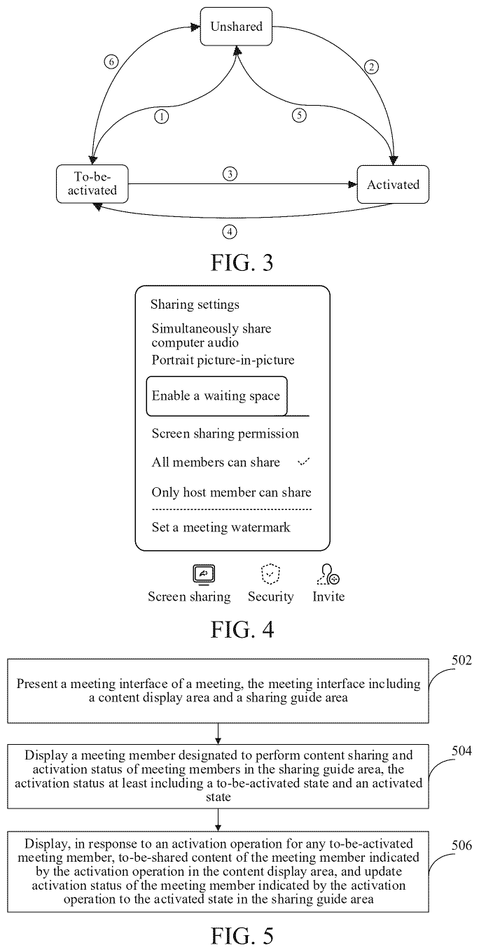

In some embodiments, status of a meeting member can be switched. FIG. 3 is a diagram of status of a meeting member according to an embodiment. It can be seen from FIG. 3 that switching of the status of the meeting member includes the following several cases:

1. When a meeting member does not enter a waiting space, status corresponding to the meeting member is an unshared state, to-be-shared content corresponding to the meeting member cannot be seen by other meeting members, and a total quantity of meeting members in the waiting space is 0. After the meeting member in the unshared state enters the waiting space, the status of the meeting member is switched from the unshared state to a to-be-activated state, and the total quantity of meeting members in the waiting space is increased by 1.

2. If a total quantity of meeting members in a waiting space is 1 after a meeting members in an unshared state enters the waiting space, status of the meeting member is directly switched from the unshared state to an activated state.

3. After a host terminal activates a to-be-activated meeting member, status of the meeting member is switched from the to-be-activated state to an activated state, to-be-shared content corresponding to the meeting member can be seen by other meeting members, status of other meeting members in a waiting space is switched to the to-be-activated state, and a total quantity of meeting members in the waiting space remains unchanged.

4. When a host terminal activates another meeting member in a waiting space, status of a meeting member in an activated state is switched from the activated state to a to-be-activated state, and a total quantity of meeting members in the waiting space remains unchanged.

5. After a meeting member in an activated state exits a waiting space, status of the meeting member is switched from the activated state to an inactivated state, and a total quantity of meeting members in the waiting space is reduced by 1.

6. After a meeting member in a to-be-activated state exits a waiting space (a meeting member of a participant terminal closes to-be-shared content to be activated of the meeting member), status of the meeting member is switched from the to-be-activated state to an unshared state, and a total quantity of meeting members in the waiting space is reduced by 1.

Alternatively, when a host terminal closes the waiting space, status of all to-be-activated meeting members is switched to the unshared state, and the total quantity of meeting members in the waiting space is reset to zero. Alternatively, the host terminal removes one to-be-activated meeting member from the waiting space, status of the meeting member is switched from the to-be-activated state to the unshared state, and the total quantity of meeting members in the waiting space is reduced by 1.

Specifically, after receiving activation status, to-be-shared content, and member information of a meeting members in a waiting space, the host terminal displays activation status, to-be-shared content, and member information of meeting members in the waiting space on an interface of the host terminal, detects an activation operation performed by a user on any meeting member in the displayed meeting members, and generates an activation instruction according to the detected activation operation. The host terminal transmits the activation instruction to the server. After receiving the activation instruction, the server transmits to-be-shared content of a meeting member indicated by the activation instruction to the participant terminals used by the meeting members participating in the meeting, to achieve content sharing.

According to the foregoing content sharing method, after the content sharing request initiated by the meeting member participating in the meeting is received, the meeting member designated to perform content sharing may be added to the waiting space, and the meeting member in the waiting space are fed back to the host terminal of the meeting. In this process, a plurality of meeting members who are in the meeting and who need to perform content sharing wait in the waiting space. When switching of content sharing is required, the host terminal may directly activate switching of content sharing, to achieve switching of shared content. In the entire switching process, a meeting member who is performing content sharing does not need to stop sharing, a meeting member designated to perform content sharing does not need to enable sharing, and seamless switching of shared content in the meeting can be achieved. In this way, a sharing operation process in the meeting is simplified, and the content sharing efficiency is enhanced.

In an embodiment, before the meeting member designated to perform content sharing is determined in response to the content sharing request initiated by the meeting member participating in the meeting, and the meeting member designated to perform content sharing is added to the waiting space, the content sharing method further includes: the waiting space is enabled in response to an enabling instruction that is transmitted by the host terminal and that is configured for enabling the waiting space.

The enabling instruction is generated according to an enabling operation generated on the host terminal. The enabling operation may be a trigger operation of the host terminal for an enabling control configured for enabling the waiting space.

For example, FIG. 4 is a schematic diagram of an enabling control configured for enabling a waiting space on a host terminal according to an embodiment. After a host member triggers a “Share a screen” control in FIG. 4, a sharing setting interface is displayed. The sharing setting interface presents a sharing setting prompt window, and the sharing setting prompt window displays sharing settings for content sharing. For example, the sharing settings include options such as “Simultaneously share terminal audio”, “Portrait picture-in-picture, “Enable a waiting space”, and “Set a meeting watermark”. “Enable a waiting space” is an enabling control configured for enabling a waiting space. “Portrait picture-in-picture” refers to superposition an image of a meeting member who is performing content sharing on a content display area. In this way, other meeting members in a meeting can more immersively view to-be-shared content. After the “Enable a waiting space” is clicked/tapped once, the waiting space is enabled, and after the “Enable a waiting space” is clicked/tapped once again, the waiting space is disabled. In FIG. 4, a screen sharing permission may further be set. The screen sharing permission includes options such as “All members can share” and “Only host member can share”. After the screen sharing permission is set, a host terminal generates an enabling instruction according to content of a triggered selected option, and transmits the enabling instruction to a server. The server enables a waiting space. The trigger operation for the foregoing controls may be a touch operation, a double-click/double-tap operation, a slide operation, a voice operation, or the like in addition to a click/tap operation. This is not limited in the embodiments of this application.

Specifically, the host member triggers an enabling control configured for enabling a waiting space on a host terminal. The host terminal detects a trigger operation for the enabling control, generates an enabling instruction, and transmits the enabling instruction for the waiting space to a server. The server enables the waiting space according to the enabling instruction.

In the foregoing embodiments, the waiting space is enabled only after the server receives the enabling instruction of the host terminal, whereby security of the waiting space is enhanced, and the problem that a meeting member enters the waiting space without the knowledge of the host terminal, and the problem that the host terminal fails to receive a content sharing request or fails to process the content sharing request timely due to network problems, which disables a meeting member in the waiting space to share to-be-shared content and reduces the content sharing efficiency, are avoided.

In an embodiment, the operation of determining a meeting member designated to perform content sharing in response to a content sharing request initiated by a meeting member participating in a meeting, and adding the meeting member designated to perform content share to a waiting space includes:
the content sharing request that is initiated by the meeting member participating in the meeting is received, and the meeting member who initiates the content sharing request is determined as the meeting member designated to perform content sharing, the content sharing request including to-be-shared content; the content sharing request is forwarded to a host terminal, to instruct the host terminal to review the to-be-shared content in the content sharing request; and when the to-be-shared passes the review, the meeting member designated to perform share content is added to the waiting space.

Review of the to-be-shared content in the content sharing request by the host terminal specifically refers to review of whether the to-be-shared content meets meeting requirements.

Specifically, the server receives a content sharing request that is initiated by a meeting member participating in a meeting, determines the meeting member who initiates the content sharing request as a meeting member designated to perform content sharing, and forwards the content sharing request to the host terminal. The host terminal displays to-be-shared content in the content sharing request, and the host terminal reviews the to-be-shared content; and adds the meeting member designated to perform content sharing to a waiting space when the to-be-shared content passes the review; or transmits a review result to the server when the to-be-shared content fails to pass the review. The server forwards the review result to the meeting member, and rejects entry of the meeting member who initiates the content sharing request to the waiting space.

In some embodiments, after reviewing the to-be-shared content, the host terminal transmits a review result to the server, and the server forwards the review result to the meeting member. The review result includes two cases that the to-be-shared content passes the review and that the to-be-shared content fails to pass the review. For example, in a scenario in which an image involved in the to-be-shared content is unclear, a text expression is incorrect, or the to-be-shared content is unrelated to this meeting, the host terminal determines that the to-be-shared content fails to pass the review, returns a review result to the server, and the server rejects entry of the meeting member who initiates the content sharing request to the waiting space.

In this embodiment, the server forwards the content sharing request to the host terminal, to instruct the host terminal to review the to-be-shared content in the content sharing request; adds the meeting member designated to perform content sharing to the waiting space when the to-be-shared content passes the review. This prevents to-be-shared content that fails to meet the meeting requirements from being incorrectly shared, and avoids reduction in the content sharing efficiency.

In an embodiment, after the meeting member designated to perform content sharing is added to the waiting space, the content sharing method further includes: a total quantity of meeting members currently in the waiting space is determined; and if the total quantity is equal to one, the to-be-shared content of the meeting member who initiates the content sharing request is directly transmitted to participant terminals used by meeting members participating in the meeting.

The total quantity of meeting members in the waiting space varies. After the waiting space is enabled, a quantity of meeting members stored in the waiting space is zero. After one meeting member is added to the waiting space, the quantity of meeting members in the waiting space is increased by one. After one meeting member is removed from the waiting space, the quantity of meeting members in the waiting space is reduced by one. After the waiting space is disabled, the quantity of meeting members stored in the waiting space is reset to zero. A case that the total quantity of meeting members in the waiting space is equal to one indicates there is only one meeting member currently in the waiting space.

When to-be-shared content of a participant terminal is shared (a meeting member of the participant terminal enters the waiting space), and the total quantity of meeting members in the waiting space is equal to 1, the to-be-shared content of the participant terminal is directly activated, and the to-be-shared content is seen by meeting members of other participant terminals. The total quantity of meeting members in the waiting space is increased by 1.

When to-be-shared content of a participant terminal is shared (a meeting member of the participant terminal enters the waiting space), and the total quantity of meeting members in the waiting space is greater than 1, the meeting member is in a to-be-activated state, and the to-be-shared content of the meeting member cannot be seen by other participants. The total quantity of meeting members in the waiting space is increased by 1.

Specifically, after enabling the waiting space, the server collects statistics on the total quantity of meeting members currently in the waiting space. If the total quantity is equal to one, in this case, the server directly transmits the to-be-shared content of the meeting member who initiates the content sharing request to the participant terminals used by the meeting members participating in the meeting.

In this embodiment, when the total quantity of meeting members currently in the waiting space is equal to one, the to-be-shared content of the meeting member who initiates the content sharing request can be directly transmitted to the participant terminals used by the meeting members participating in the meeting without the need for an activation instruction of the host terminal. In this way, a content sharing operation process is simplified, and the content sharing efficiency is enhanced.

In an embodiment, the content sharing method further includes an operation of terminating content sharing. The operation includes: when a content closing request is received, a meeting member who initiates the content closing request is removed from the waiting space; and if the meeting member who initiates the content closing request is a meeting member who is currently performing content sharing, current content sharing is terminated.

The content closing request carries member information of the meeting member who initiates the content closing request. The content closing request is transmitted by a meeting member who is in the waiting space and who is designated to perform content sharing or is performing content sharing. For example, according to the meeting progress, a meeting member A designated to perform content sharing in the waiting space does not need to perform content sharing. In this case, the meeting member A initiates a content closing request to the server, to exit the waiting space. For example, when a meeting member B who is performing content sharing needs to terminate current content sharing, the meeting member B transmits a content closing request to the server, to terminate current content sharing.

Specifically, when the server receives a content closing request, the server parses the content closing request, to obtain member information of a meeting member who initiates the content closing request, and removes the meeting member corresponding to the member information from a waiting space according to the member information obtained through parsing; and terminates current content sharing if the meeting member who initiates the content closing request is a meeting member who is currently performing content sharing.

In this embodiment, when the server receives the content closing request, the server can directly remove the meeting member who initiates the content closing request from the waiting space without waiting for the host terminal to determine; and can directly terminate current content sharing without waiting for the host terminal to determine when the meeting member who initiates the content closing request is the meeting member who is currently performing content sharing. In this way, a content sharing termination process is simplified, and the content sharing efficiency is enhanced.

In an embodiment, in a case of a plurality of content sharing requests, the operation of adding the meeting member designated to perform content sharing to a waiting space includes: a plurality of meeting members designated to perform content sharing are added to the waiting space; and the meeting members in the waiting space are sorted in a preset sorting manner.

The preset sorting manner may be a specified sequence; or a sorting manner based on a time sequence of the content sharing request initiated by each meeting member; or a sorting manner based on a sequence in which each meeting member is invited to participate in the meeting; or a sorting manner based on the rank of the meeting members, where the rank refers to a hierarchical level within an organizational structure tree; or a sorting manner based on an initial letter of a surname of each meeting member; or a sorting manner based on a sequence of a location of each meeting member; or a sorting manner based on a descending order of network communication status of each meeting member. This is not limited in the embodiments of this application.

Specifically, in a case of a plurality of content sharing requests, the server returns a plurality of meeting members designated to perform content sharing to the host terminal. After the plurality of content sharing requests pass the review, the host terminal adds the plurality of meeting members to a waiting space. The server sorts meeting members in the waiting space in a preset sorting manner.

In some embodiments, the method further includes an operation of automatically performing content sharing. The operation of automatically performing content sharing specifically includes: current content sharing is terminated if a content closing request initiated by a meeting member who is currently performing content sharing is received, and to-be-shared content of a next meeting member ranked after the meeting member who is currently performing content sharing is transmitted to the participant terminals used by the meeting members participating in the meeting.

The server may determine an automatic sharing sequence of each meeting member in the waiting space based on a sorting sequence of the meeting member in the waiting space. For example, if a next member ranked after a meeting member A in the waiting space is a meeting member B, after the meeting member A terminates content sharing, the server can automatically transmit to-be-shared content of the meeting member B to the participant terminals used by the meeting members based on the sorting sequence of the meeting members in the waiting space without the need for an activation instruction of the host terminal.

In some embodiments, after the meeting members in the waiting space are sorted, if the server receives a content closing request initiated by a meeting member designated to perform content sharing, the server removes the meeting member who initiates the content closing request from the waiting space, and updates the sorting sequence in the waiting space. After current content sharing is terminated, the server automatically transmits, according to the updated sorting sequence, to-be-shared content of a next meeting member ranked after the meeting member who is currently performing content sharing to the participant terminals used by the meeting members participating in the meeting.

For example, the sorting sequence of the meeting members in the waiting space is a meeting member A, a meeting member B, and a meeting member C, the meeting member who is currently performing content sharing is the meeting member A, before the meeting member A terminates current content sharing, the meeting member B transmits a content closing request, and the server removes the meeting member B from the waiting space. In this case, the sorting sequence of the meeting members in the waiting space is updated to the meeting member A and the meeting member C. After the meeting member A terminates current content sharing, the server automatically transmits to-be-shared content of the meeting member C to the participant terminals used by the meeting members participating in the meeting.

In this embodiment, the server sorts the meeting members in the waiting space according to the preset sorting manner, terminates current content sharing after receiving the content closing request initiated by the meeting member who is currently performing content sharing, and automatically transmits the to-be-shared content of the next meeting member ranked after the meeting member who is currently performing content sharing to the participant terminals used by the meeting members participating in the meeting. In this way, automatic switching of content sharing is achieved without the need of activating the next meeting member by the host terminal, an operation process of the host terminal is simplified, and the content sharing efficiency is enhanced.

In an embodiment, the content sharing method further includes an operation of removing a meeting member from the waiting space. The operation of removing a meeting member from the waiting space includes:
in response to a removal instruction transmitted by the host terminal, any meeting member indicated by the removal instruction is determined from the meeting members displayed by the host terminal, and the meeting member indicated by the removal instruction is removed from the waiting space; and current content sharing is terminated if the meeting member indicated by the removal instruction is the meeting member who is currently performing content sharing.

The removal instruction is generated by the host terminal according to a trigger operation for a removal control of any meeting member on a meeting interface of the host terminal. The meeting member indicated by the removal instruction is a to-be-activated meeting member or an activated meeting member in the waiting space. For example, a host member triggers a removal control of any meeting member on the meeting interface of the host terminal. After detecting a trigger operation for the removal control of the meeting member, the host terminal generates a removal instruction for the meeting member according to the trigger operation, and transmits the removal instruction to the server. The server removes the meeting member indicated by the removal instruction from the waiting space.

Removal of a meeting member from the waiting space may include two cases, one is that the meeting member actively exits the waiting space, and the other one is that the meeting member is removed from the waiting space by the host terminal. When the meeting member actively exits the waiting space, the meeting member can exist the waiting space without the need for permission of the host terminal. When a trigger operation for a removal control of a meeting member who is performing content sharing or is designated to perform content sharing is generated in the host terminal, a removal instruction is generated according to the trigger operation, and the removal instruction is fed back to the server. The server removes, according to the removal instruction that is transmitted by the host terminal for any meeting member in the displayed meeting members, the meeting member indicated by the removal instruction from the waiting space.

In this embodiment, when the host terminal removes the meeting member who is performing content sharing or designated to perform content sharing from the waiting space, the server removes, according to the removal instruction that is transmitted by the host terminal for any meeting member in the displayed meeting members, the meeting member indicated by the removal instruction from the waiting space. A function of removing a meeting member from the waiting space is provided for the host terminal, which helps the server quickly remove the meeting member from the waiting space without the need for an operation of the meeting member participating in the meeting. In this way, an operation process of exiting the waiting space by the meeting member is simplified, and the content sharing efficiency is enhanced.

In an embodiment, the content sharing method further includes an operation of disabling the waiting space. The operation of disabling the waiting space includes: in response to a disabling instruction transmitted by the host terminal, the waiting space is disabled; and to-be-shared content of a meeting member who is originally in a to-be-activated state in the waiting space is closed, and a sharing operation for to-be-shared content of a meeting member who is originally in an activated state in the waiting space is maintained.

The disabling instruction is configured for instructing the server to disable the waiting space, and the disabling instruction is generated according to a trigger operation of the host terminal for a waiting space disabling control. After the waiting space is disabled, the host terminal no longer displays the meeting members in the waiting space.

In some embodiments, “Enable a waiting space” in a sharing setting prompt window shown in FIG. 4 is clicked/tapped once through the host terminal, and after detecting a first trigger operation for “Enable a waiting space”, the host terminal generates an enabling instruction for the waiting space according to the first trigger operation. “Enable a waiting space” in the sharing setting prompt window shown in FIG. 4 is clicked/tapped once again through the host terminal, and after detecting a second trigger operation for “Enable a waiting space”, the host terminal generates a disabling instruction for the waiting space according to the second trigger operation.

Specifically, the server receives a disabling instruction transmitted by the host terminal for a waiting space, disables the waiting space and closes to-be-shared content of a meeting member who is originally in a to-be-activated state in the waiting space in response to the disabling instruction, and maintains a sharing operation for to-be-shared content of a meeting member who is originally in an activated state in the waiting space.

In this embodiment, after receiving the disabling instruction that is transmitted by the host terminal for the waiting space, the server closes the to-be-shared content of the meeting member who is originally in the to-be-activated state in the waiting space, and maintains the sharing operation for the to-be-shared content of the meeting member who is originally in the activated state in the waiting space. In this way, the meeting member who is originally performing content sharing maintains the sharing operation, to avoid interruption of current content sharing and reduction in the content sharing efficiency.

In an embodiment, as shown in FIG. 5, a content sharing method is provided. A description is made by using an example in which the method is applied to the host terminal in FIG. 1. The method includes:

Operation 502: Present a meeting interface of a meeting, the meeting interface including a content display area and a sharing guide area.

The content display area is configured for displaying shared content in the meeting. The sharing guide area of the host terminal is configured for displaying a meeting member in a waiting space, whereby the host terminal can perform switching of to-be-shared content. For example, the sharing guide area may display member information (such as a name or an avatar) and activation status of the meeting member in the waiting space. In another scenario, the sharing guide area may further display to-be-shared content and the like of the meeting member in the waiting space.

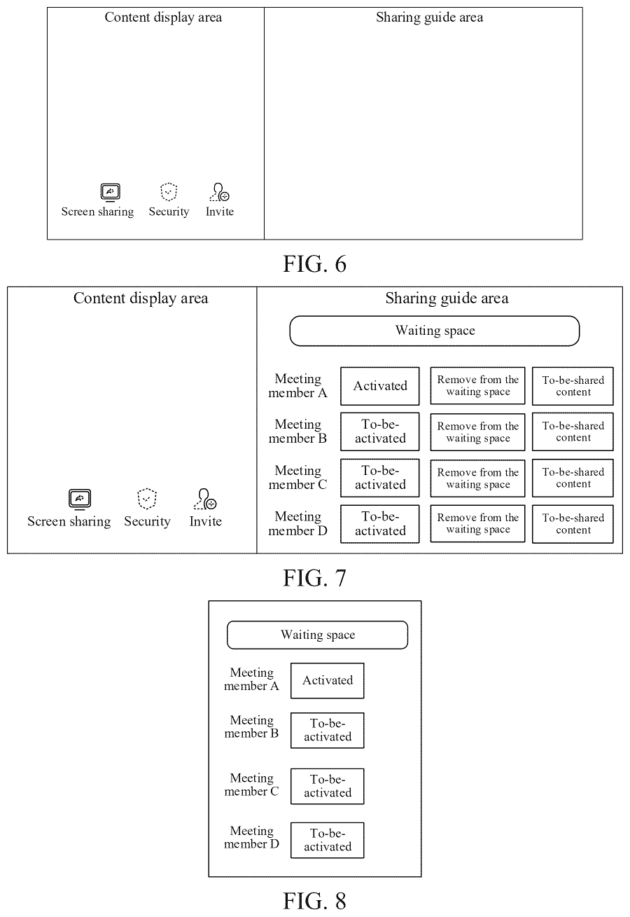

In some embodiments, FIG. 6 is a schematic diagram of a display interface of a host terminal when a waiting space is not enabled according to an embodiment. It can be seen from FIG. 6 that when the host terminal does not enable the waiting space, to-be-shared content and member information of any meeting member are not displayed in a sharing guide area. FIG. 7 is a schematic diagram of a display interface of a host terminal after a waiting space is enabled according to an embodiment. It can be seen from FIG. 7 that after the host terminal enables the waiting space, activation status, member information, and to-be-shared content of a meeting member in the waiting space are displayed in a sharing guide area.

Specifically, the host terminal establishes a multi-person online meeting, and presents a meeting interface of the meeting after the meeting is successfully established. If a waiting space is not enabled, to-be-shared content and member information of any meeting member are not displayed in a sharing guide area of the meeting interface. If the waiting space is enabled, activation status, member information, and to-be-shared content of a meeting member in the waiting space are displayed in the sharing guide area.

Operation 504: Display a meeting member designated to perform content sharing and activation status of meeting members in the sharing guide area, the activation status at least including a to-be-activated state and an activated state.

Status of a meeting member who does not enter the waiting space is an unshared state, and activation status of a meeting member who enters the waiting space includes a to-be-activated state and an activated state. For example, the host terminal controls the waiting space to be enabled, and controls a meeting member in an unshared state to enter the waiting space. In this case, initial status of the meeting member who enters the waiting space is a to-be-activated state. After the host terminal activates the meeting member, the status of the meeting member is switched from the to-be-activated state to an activated state.

Specifically, the host terminal obtains activation status, member information, and to-be-shared content of meeting members in a waiting space through a server, and displays the activation status, the member information, and the to-be-shared content of the meeting members in the waiting space in a sharing guide area. For the first meeting member who enters the waiting space, activation status of the meeting member is switched from an inactivated state to an activated state, activation status of other meeting members in the waiting space is a to-be-activated state, and the activation status of the meeting members in the waiting space is displayed in the sharing guide area.

In some embodiments, FIG. 8 is a schematic diagram of meeting members in a waiting space and activation status of the meeting members displayed by a host terminal according to an embodiment. In FIG. 8, a meeting member A is a name of a meeting member, and the meeting member A is the first meeting member who enters the waiting space or a meeting member who is activated by the host terminal. Therefore, activation status of the meeting member A is an activated state, and activation status of other meeting members is a to-be-activated state.

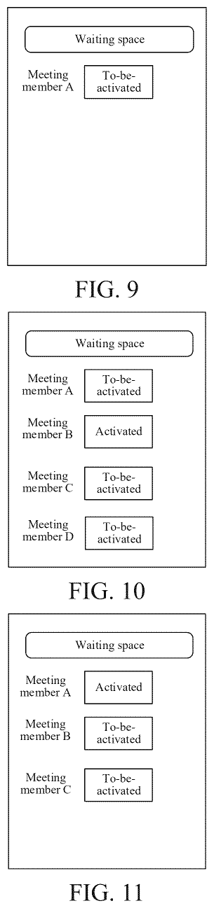

In some embodiments, for a participant terminal used by a to-be-activated meeting member in the waiting space, the participant terminal generates prompt information, to prompt that the meeting member designated to perform content sharing of the participant terminal has entered the waiting space, and displays only the to-be-activated state of the meeting member designated to perform content sharing. For example, FIG. 9 is a schematic diagram of a to-be-activated state of a meeting member who enters a waiting space and who is designated to perform content sharing that is displayed by a participant terminal according to an embodiment. When a meeting member A enters the waiting space and is in a to-be-activated state, a participant terminal used by the meeting member A displays the schematic diagram shown in FIG. 9, to notify that the meeting member A has entered the waiting space.

Operation 506: Display, in response to an activation operation for any to-be-activated meeting member, to-be-shared content of the meeting member indicated by the activation operation in the content display area, and update activation status of the meeting member indicated by the activation operation to the activated state in the sharing guide area.

The activation operation may refer to triggering an activation control configured for switching any to-be-activated meeting member in the waiting space. The activation control may be a switch control (such as a slide switch control or a toggle switch control). The activation status of the meeting member is switched by toggling an on/off state of the switch control. In some embodiments, the activation control may be a state transition control, and the activation status of the meeting member may be switched by single-clicking/single-tapping the state transition control.

Specifically, for any to-be-activated meeting member in a waiting space, the host member triggers an activation control of the to-be-activated meeting member. After the host terminal of the host member detects an activation operation of the host member for any to-be-activated meeting member in the waiting space, in response to the activation operation, the host terminal performs switching from to-be-shared content that is currently shared and that is displayed in a content display area of the host terminal to to-be-shared content of a meeting member indicated by the activation operation, updates activation status of the meeting member indicated by the activation operation to an activated state in a sharing guide area, and updates activation status of a meeting member who previously performs content sharing to a to-be-activated state.

In some embodiments, the host terminal can switch activation status of any meeting member in the waiting space. For example, in FIG. 8, a meeting member who is currently performing content sharing is a meeting member A, and activation status of a meeting member B is a to-be-activated state. In this case, the meeting member who is currently performing content sharing can be switched from the meeting member A to the meeting member B by clicking/tapping the to-be-activated state of the meeting member B. After switching, the sharing guide area of the host terminal is shown in FIG. 10.

In some embodiments, if a meeting member designated to perform content sharing on a participant terminal initiates a content closing request to the server, and the server forwards the content closing request to the host terminal, the meeting member who initiates the content closing request is not displayed in the sharing guide area of the host terminal. For example, FIG. 11 is a schematic diagram of a sharing guide area of a host terminal according to another embodiment. After a to-be-activated meeting member D in FIG. 8 transmits a content closing request, as shown in FIG. 11, the meeting member D is no longer displayed in the sharing guide area of the host terminal. After the meeting member D initiates the content closing request, in response to an activation operation for any to-be-activated meeting member, the host terminal displays to-be-shared content of the meeting member indicated by the activation operation in the content display area of the host terminal, and updates activation status of the meeting member indicated by the activation operation to an activated state in the sharing guide area of the host terminal.

In some embodiments, if a meeting member who is currently performing content sharing on a participant terminal initiates a content closing request to the server, and the server forwards the content closing request to the host terminal, the meeting member who initiates the content closing request is not displayed in the sharing guide area of the host terminal, and the host terminal automatically displays, according to a sequence in which meeting members designated to perform content sharing enter the waiting space, to-be-shared content of a next meeting member ranked after the meeting member who is currently performing content sharing in the content display area of the host terminal.

In this embodiment, the sharing guide area is displayed on the meeting interface of the host terminal, the meeting member designated to perform content sharing and the activation status of the meeting member are displayed in the sharing guide area. In response to the activation operation of the host member for any to-be-activated meeting member in the waiting space, the to-be-shared content of the meeting members indicated by the activation operation is displayed in the content display area, and the activation status of the meeting member indicated by the activation operation is updated to the activated state in the sharing guide area. In the switching process, the meeting member who is performing content sharing does not need to stop sharing, the meeting member designated to perform content sharing does not need to enable sharing, and seamless switching of shared content in the meeting is achieved. In this way, a sharing operation process in the meeting is simplified, and the content sharing efficiency is enhanced.

In an embodiment, the operation of displaying meeting members in the waiting space of the meeting and activation status of the meeting members in the sharing guide area includes the following operations:
the meeting members designated to perform content sharing are displayed in an itemized list in the sharing guide area, and activation status of each meeting member is displayed within a preset proximity range of the meeting member.

Displaying in an itemized list refers to presentation of meeting members in the sharing guide area as individual entries in a list format.

The preset proximity range refers to a range within the sharing guide area that is at a preset proximity distance from a meeting member. For example, the preset proximity range of the meeting member may be a position that is on the right side of the meeting member and that is at a preset distance from the meeting member. For example, the preset proximity range of the meeting member may be a defined range of a row where the meeting member is located in the sharing guide area.

Specifically, the host terminal displays, in a sharing guide area of a meeting interface of the host terminal, meeting members in a waiting space of a meeting in itemized list, and presents activation status of each meeting member within a preset proximity range of the meeting member.

For example, as shown in FIG. 8 or FIG. 10, the host terminal displays meeting members in a waiting space in an itemized list in a sharing guide area of a meeting interface, and displays activation status of each meeting member on the right side of the meeting member.

In this embodiment, the host terminal displays the meeting members in the waiting space of the meeting in the itemized list in the sharing guide area to help the host member clearly determine activation status of each meeting member, and displays the activation status of each meeting member within the preset proximity range of the meeting member to help the host member rapidly find the activation control when switching the meeting member who is currently performing content sharing. In this way, switching of screens is achieved, and the content sharing efficiency is enhanced.

In an embodiment, the operation of displaying activation status of each meeting member within a preset proximity range of the meeting member includes: the activation status of each meeting member is displayed within the preset proximity range of the meeting member, and a removal control is displayed within a preset proximity range of each to-be-activated meeting member, the removal control being configured for removing a meeting member from the waiting space.

Specifically, the host terminal displays activation status of each meeting member within a preset proximity range of the meeting member, and displays a removal control within a preset proximity range of each to-be-activated meeting member.

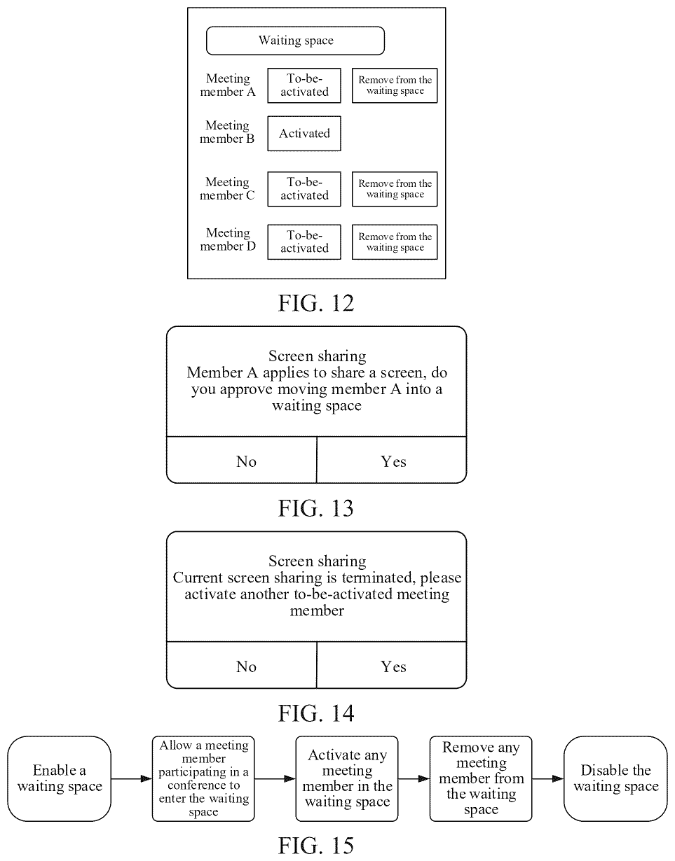

FIG. 12 is a schematic diagram of a removal control within a preset proximity range according to an embodiment. As shown in FIG. 12, activation status and a removal control of the same meeting member are displayed in the same row. By triggering a “Remove from the waiting space” control behind a meeting member in a to-be-activated state in FIG. 12, the meeting member in the to-be-activated state can be removed from the waiting space.

In some embodiments, for an activated meeting member in the waiting space, the host terminal may switch the status of the meeting member from the activated state to a to-be-activated state in response to a switching operation for the activated meeting member in the waiting space, and present the removal control within the preset proximity range of the meeting member in the to-be-activated state. The host terminal may remove the corresponding meeting member from the waiting space in response to a trigger operation for the removal control.

In some embodiments, the host terminal may further display the removal control within a preset proximity range of an activated meeting member. By triggering the removal control displayed within the preset proximity range of the activated meeting member, the activated meeting member can be removed from the waiting space.

In this embodiment, the host terminal displays the activation status of each meeting member in the waiting space in the sharing guide area, and displays the removal control in the preset proximity range of each to-be-activated meeting member. In this way, the removal control can be rapidly found, to remove the meeting member in the to-be-activated state from the waiting space, and the content sharing efficiency is enhanced.

In an embodiment, to help the host terminal perform switching from a meeting member who is currently performing content sharing, a preview function is provided for the host member, to allow the host member to perform switching to require to-be-shared content. In this embodiment, the content sharing method further includes: respective corresponding to-be-shared content is displayed within a preset proximity range of each to-be-activated meeting member.

The to-be-shared content of the to-be-activated meeting member is displayed within the preset proximity range of the meeting member in a form of a thumbnail. By previewing to-be-shared content of a to-be-activated meeting member, the host member determines whether the to-be-shared content of the to-be-activated meeting member needs to be displayed in the content display area of the meeting interface.

In this embodiment, the host terminal displays the respective corresponding to-be-shared content within the preset proximity range of each to-be-activated meeting member. During subsequent switching from the meeting member who is currently performing content sharing, the to-be-shared content displayed in the preset proximity range may be taken as a reference basis, to determine whether the to-be-shared content of the to-be-activated meeting member needs to be displayed in the content display area of the meeting interface. In this way, switching to the required to-be-shared content is rapidly performed.

In an embodiment, the content sharing method further includes the following operations: in response to a content sharing request initiated by a meeting member participating in the meeting, first prompt information is displayed; and in response to an allowance operation for the first prompt information, the meeting member who initiates the content sharing request is added to the sharing guide area for displaying.

A participant terminal transmits the content sharing request to the server, and then the server forwards the content sharing request to the host terminal, to request the host terminal to allow entry of the meeting member who initiates the content sharing request to the waiting space, and request the server to share to-be-shared content of the meeting member who initiates the content sharing request with other meeting members in the meeting.

In some embodiments, for the first meeting member who initiates a content sharing request, the server directly adds the meeting member to the waiting space, and the first prompt information does not need to be displayed on the meeting interface of the host terminal. For the second or any subsequent meeting member who initiates a content sharing request, the first prompt information is displayed on the meeting interface of the host terminal, and for an allowance operation for the first prompt information, the server adds the meeting member designated to perform content sharing to the waiting space.

The allowance operation of the host terminal for the first prompt information indicates that the host terminal reviews the content sharing request and a review result indicates that the content sharing request passes the review.

In some embodiments, the first prompt information is configured for prompting an allowance or disallowance operation of the host terminal for the meeting member who initiates the content sharing request. The first prompt information includes prompt content, an allowance operation control, and a disallowance operation control. The prompt content is configured for displaying content that needs to be determined by the host terminal. The host terminal triggers the allowance operation control, which indicates that the host terminal agrees with the prompt content of the first prompt information and the content sharing request passes the review. The host terminal triggers the disallowance operation control, which indicates that the host terminal does not agree with the prompt content of the first prompt information and the content sharing request fails to pass the review.

For example, FIG. 13 is a schematic diagram of first prompt information according to an embodiment. Prompt content of the first prompt information is “Member A applies to share a screen, do you approve moving member A into a waiting space”, a corresponding allowance operation control is a “Yes” control in FIG. 13, and a corresponding disallowance operation control is a “No” control in FIG. 13. After the host terminal triggers “Yes” in FIG. 13, the host terminal adds the meeting member A who initiates the content sharing request to the sharing guide area for displaying.

In this embodiment, the host terminal displays the first prompt information in response to the content sharing request initiated by the meeting member participating in the meeting, and adds, in response to the allowance operation for the first prompt information, the meeting member who initiates the content sharing request to the sharing guide area for displaying. In this process, the host terminal determines, according to the first prompt information, a meeting member who enters the waiting space, and can reject entry of a meeting member who does not participate in the meeting or a meeting member who does not need to perform content sharing in the meeting to the waiting space. In this way, the content sharing efficiency is enhanced.

In an embodiment, the content sharing request method further includes: when current content sharing is terminated, second prompt information is displayed, the second prompt information being configured for instructing to activate another to-be-activated meeting member; and in response to a switching operation for the second prompt information, an activation operation for any to-be-activated meeting member is detected, and when the activation operation is detected, switching to display to-be-shared content of the meeting member indicated by the activation operation is performed.

The case that current content sharing is terminated specifically refers to either a meeting member who is currently performing content sharing closing currently shared content, to terminate current content sharing, or the host terminal removing the meeting member who is performing content sharing from the waiting space, to terminate current content sharing. After current content sharing is terminated, the meeting member who terminates content sharing is not displayed in the sharing guide area of the host terminal.

In some embodiments, the second prompt information includes prompt content configured for prompting the host terminal to activate another to-be-activate meeting member, a confirmation control, and a denial control. The prompt content is configured for displaying content that needs to be determined by the host terminal. The host terminal triggers the confirmation control, which indicates that the host terminal agrees with the prompt content of the second prompt information. The host terminal triggers the denial control, which indicates that the host terminal does not agree with the prompt content of the second prompt information.

In some embodiments, the switching operation for the second prompt information refers to a switching operation of the host terminal, according to the prompt content in the second prompt information, for triggering the confirmation control between the confirmation control and the denial control in the second prompt information. For example, FIG. 14 is a schematic diagram of second prompt information according to an embodiment. Prompt content of the second prompt information in FIG. 14 is “Current content sharing is terminated, please activate another to-be-activated meeting member”, a corresponding confirmation control is a “Yes” control in FIG. 14, and a denial control is a “No” control in FIG. 14. For the second prompt information in FIG. 14, the switching operation refers to performing an operation of switching to the “Yes” control by selecting between the “Yes” control and the “No” control in FIG. 14. The “Yes” control in FIG. 14 is triggered, the host member performs an activation operation for any to-be-activated meeting member in the waiting space, and the host terminal detects the activation operation of the host member for any to-be-activated meeting member in the waiting space. The “No” control in FIG. 14 is triggered, which indicates pausing current to-be-shared content, the host member no longer performs an activation operation for any to-be-activated meeting member in the waiting space, and the meeting enters a paused state.

Specifically, when current content sharing is terminated, the host terminal displays second prompt information, and a host member performs an operation according to prompt content of the second prompt information. If the host terminal triggers a confirmation control in the second prompt information, the host member performs an activation operation for any to-be-activated meeting member in a waiting space. After detecting the activation operation of the host member for any to-be-activated meeting member in the waiting space, the host terminal displays to-be-shared content of the meeting member indicated by the activation operation in a content display area of the host terminal. If the host terminal triggers a denial control in the second prompt information, the host member no longer performs an activation operation for any to-be-activated meeting member in the waiting space, and the meeting enters a paused state.

In an embodiment, FIG. 15 is a schematic diagram of operational logic of a host terminal according to an embodiment. It can be seen from FIG. 15 that a host terminal performs operations of enabling a waiting space, allowing a meeting member participating in a meeting to enter the waiting space, activating any meeting member in the waiting space, removing any meeting member from the waiting space, and disabling the waiting space.

In the operation of enabling the waiting space, if the host terminal does not enable the waiting space, a meeting member implements content sharing in an existing manner, that is, content sharing can be implemented only after a participant who is currently sharing a screen terminates sharing. If the host terminal enables the waiting space, the host terminal can perform seamless switching of a plurality of pieces of to-be-shared content.

In the operation of allowing the meeting member participating in the meeting to enter the waiting space, a host member of the host terminal determines whether to allow a meeting member to enter the waiting space.

In the operation of activating any meeting member in the waiting space, the host member of the host terminal activates any meeting member in the waiting space. In the same time period, only one meeting member is in an activated state, and other meeting members are in a to-be-activated state.

In the operation of removing any meeting member from the waiting space, the host member of the host terminal may remove a to-be-activated or activated meeting member in the waiting space from the waiting space.

In the operation of disabling the waiting space, the host member of the host terminal may disable the waiting space. After the waiting space is disabled, to-be-shared content of all to-be-activated meeting members is closed, and sharing of to-be-shared content of an activated meeting member can be continued.

In this embodiment, when current content sharing is terminated, the second prompt information is displayed. In response to the switching operation of the host member for the second prompt information and the activation operation for any to-be-activated meeting member in the waiting space, the host terminal displays the to-be-shared content of the meeting member indicated by the activation operation in the content display area of the host terminal. When current content sharing is terminated, to-be-shared content of another to-be-activated meeting member is displayed in the content display area. In this way, switching of to-be-shared content can be achieved without the need of enabling content sharing by a participant, and the content sharing efficiency is enhanced.

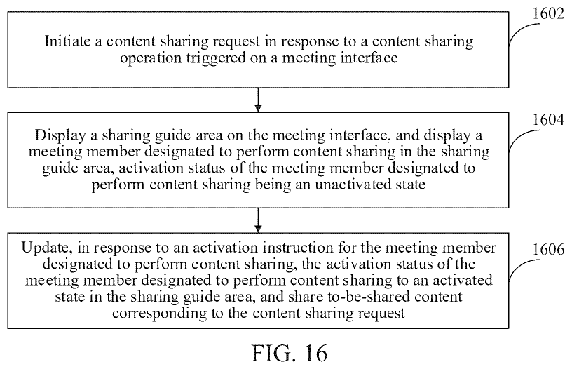

In an embodiment, as shown in FIG. 16, a content sharing method is provided. A description is made by using an example in which the method is applied to the participant terminal in FIG. 1. The method includes the following operations:

Operation 1602: Initiate a content sharing request in response to a content sharing operation triggered on a meeting interface.

The content sharing operation refers to an action that a participant triggers a content sharing control on a meeting interface of a participant terminal. The content sharing control refers to a button configured for operating to-be-shared content of the participant terminal for displaying.

The content sharing request is initiated by a participant terminal, is specifically generated by the participant terminal according to the content sharing operation triggered on the meeting interface by a meeting member designated to perform content sharing, and is configured for requesting a server to perform content sharing.

In some embodiments, the content sharing request may carry to-be-shared content and member information of the meeting member who initiates the content sharing request.

Specifically, a participant transmits, on a meeting interface of a participant terminal used by the participant, a content sharing operation for a content sharing control on the meeting interface. After detecting the content sharing operation transmitted by the participant, the participant terminal generates a content sharing request in response to the content sharing operation, and transmits the content sharing request to the server. The server forwards the content sharing request to a host terminal.

Operation 1604: Display a sharing guide area on the meeting interface, and display a meeting member designated to perform content sharing in the sharing guide area, activation status of the meeting member designated to perform content sharing being an inactivated state.

The meeting member designated to perform content sharing refers to a meeting member logging in to a participant terminal. When the meeting member designated to perform content sharing enters a waiting space, initial activation status is a to-be-activated state.

The sharing guide area of the participant terminal is configured for displaying member information and activation status of a meeting member designated to perform content sharing in the waiting space. For example, a meeting interface of a participant A displays to-be-shared content that is currently shared in a meeting. As shown in FIG. 9, a sharing guide area of the participant A only presents member information and activation status of the participant A. If the host terminal transmits an activation operation for the meeting member A, the activation status of the meeting member A is switched from a to-be-activated state to an activated state.

Specifically, when the host terminal agrees to a content sharing request transmitted by a meeting member who logs in to a participant terminal and who is designated to perform content sharing, and the server adds the meeting member designated to perform content sharing to a waiting space, a sharing guide area is displayed on a meeting interface of the participant terminal, and meeting members designated to perform content sharing in the waiting space of the meeting are displayed in the sharing guide area.

In some embodiments, when the host terminal has enabled the waiting space, and no meeting member who is currently performing content sharing exists, the activation status of the meeting member who is displayed in the sharing guide area of the participant terminal and who is designated to perform content sharing is an activated state. When the host terminal has enabled the waiting space, and a meeting member who is currently performing content sharing exists, the activation status of the meeting member designated to perform content sharing on the participant terminal is the inactivated state.

Operation 1606: Update, in response to an activation instruction for the meeting member designated to perform content sharing, the activation status of the meeting member designated to perform content sharing to an activated state in the sharing guide area, and share to-be-shared content corresponding to the content sharing request.

Specifically, the host terminal transmits an activation instruction for a meeting member designated to perform content sharing on a participant terminal to the server. The server transmits, in response to the activation instruction, to-be-shared content of the meeting member indicated by the activation instruction to participant terminals used by meeting members participating in the meeting. In this way, content sharing is achieved.

In some embodiments, if the meeting member designated to perform content sharing is the first meeting member who transmits a content sharing request, the meeting member can automatically enter the waiting space without the need for consent of the host terminal, the activation status of the meeting member designated to perform content sharing is automatically switched from an initial to-be-activated state to an activated state without the need for an activation instruction transmitted by the host terminal for the meeting member designated to perform content sharing, and the activation status of the meeting member designated to perform content sharing is updated to the activated state in the sharing guide area of the participant terminal.

In some embodiments, to-be-shared content of the meeting member designated to perform content sharing may be further displayed in the sharing guide area of the participant terminal.

In this embodiment, in response to the content sharing operation triggered on the meeting interface by the participant, the content sharing request is initiated. After the host terminal agrees to the content sharing request transmitted by the meeting member who logs in to the participant terminal and who is designated to perform content sharing, the participant terminal displays the sharing guide area on the meeting interface of the participant terminal, and displays the meeting member designated to perform content sharing in the waiting space of the meeting in the sharing guide area. The activation status of the meeting member designated to perform content sharing is the inactivated state. After the host terminal transmits the activation instruction for the meeting member designated to perform content sharing, the participant terminal updates, in response to the activation instruction for the meeting member designated to perform content sharing, the activation status of the meeting member designated to perform content sharing to the activated state in the sharing guide area, and shares the to-be-shared content corresponding to the content sharing request. After the meeting member designated to perform content sharing on the participant terminal enters the waiting space, the to-be-shared content of the meeting member designated to perform content sharing can be shared only according to the activation instruction transmitted by the host terminal. In this process, the participant terminal does not need to wait for a meeting member who previously performs content sharing to close currently shared to-be-shared content. In this way, a content sharing operation process is simplified, and the content sharing efficiency is enhanced.

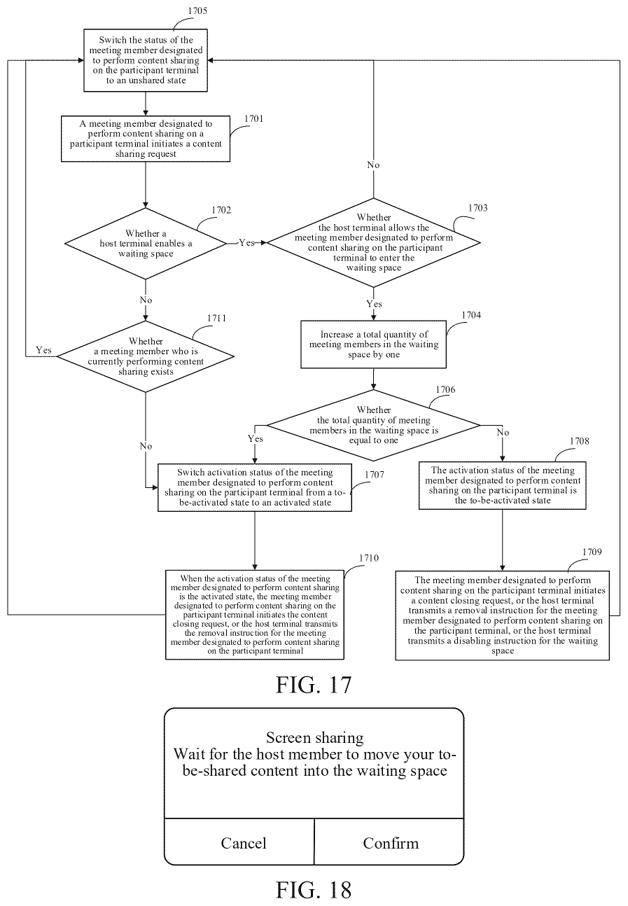

In some embodiments, FIG. 17 is a schematic diagram of control logic for performing content sharing by a participant terminal according to an embodiment. It can be seen from FIG. 17 that the following operations are specifically included:

Operation 1701: A meeting member designated to perform content sharing on a participant terminal initiates a content sharing request.

Operation 1702: Determine whether a host terminal enables a waiting space. If the host terminal enables the waiting space, operation 1703 is performed; or if the host terminal does not enable the waiting space, operation 1711 is performed.

Operation 1703: Determine whether the host terminal allows the meeting member designated to perform content sharing on the participant terminal to enter the waiting space; and perform operation 1704 if the host terminal allows the meeting member designated to perform content sharing on the participant terminal to enter the waiting space; or perform operation 1705 if the host terminal does not allow the meeting member designated to perform content sharing on the participant terminal to enter the waiting space.

Operation 1704: Increase a total quantity of meeting members in the waiting space by one, and perform operation 1706.

Operation 1705: Switch status of the meeting member designated to perform content sharing on the participant terminal to an unshared state.

Operation 1706: Determine whether the total quantity of meeting members in the waiting space is equal to one; and perform operation 1707 if the total quantity of meeting members in the waiting space is equal to one; or perform operation 1708 if the total quantity of meeting members in the waiting space is greater than one.

Operation 1707: Switch activation status of the meeting member designated to perform content sharing on the participant terminal from a to-be-activated state to an activated state, and perform operation 1710.

Operation 1708: Perform operation 1709 when the activation status of the meeting member designated to perform content sharing on the participant terminal is the to-be-activated state.

Operation 1709: Perform operation 1705 when the activation status of the meeting member designated to perform content sharing is the to-be-activated state when the meeting member designated to perform content sharing on the participant terminal initiates a content closing request, or the host terminal transmits a removal instruction for the meeting member designated to perform content sharing on the participant terminal, or the host terminal transmits a disabling instruction for the waiting space.

Operation 1710: Perform operation 1705 when the activation status of the meeting member designated to perform content sharing is the activated state when the meeting member designated to perform content sharing on the participant terminal initiates the content closing request, or the host terminal transmits the removal instruction for the meeting member designated to perform content sharing on the participant terminal.

Operation 1711: Determine whether a meeting member who is currently performing content sharing exists; and perform operation 1705 if the meeting member who is currently performing content sharing exists, operation 1705 is performed; or perform operation 1707 if no meeting member who is currently performing content sharing exists.

In an embodiment, after the content sharing request is initiated, the method further includes: third prompt information is displayed, the third prompt information being configured for indicating that the to-be-shared content carried in the content sharing request is waiting to be reviewed; and when the to-be-shared content passes the review, the meeting member designated to perform content sharing is allowed to enter the waiting space.

Specifically, after a server receives a content sharing request initiated by a participant terminal, the server forwards the content sharing request to a host terminal. The host terminal displays first prompt information, and reviews to-be-shared content in the content sharing request. In the process of reviewing the to-be-shared content by the host terminal, the participant terminal displays third prompt information, and a meeting member who logs in to the participant terminal and who is designated to perform content sharing waits. After the to-be-shared content passes the review of the host terminal, the host terminal transmits an allowance operation for the first prompt information and generates an allowance message according to the allowance operation. The server forwards the allowance message to the participant terminal, to notify that the meeting member who logs in to the participant terminal and who is designated to perform content sharing is allowed to enter the waiting space. If the to-be-shared content fails to pass the review of the host terminal, the host terminal transmits a disallowance operation for the first prompt information, and generates a disallowance message according to the disallowance operation. The server forwards the disallowance message to the participant terminal, to notify that the meeting member who logs in to the participant terminal and who is designated to perform content sharing is not allowed to enter the waiting space.

FIG. 18 is a schematic diagram of third prompt information according to an embodiment. Prompt content of the third prompt information is: Waiting for the host member to move your to-be-shared content into the waiting space.

In some embodiments, the third prompt information further includes a confirmation control configured for confirming the third prompt information and a denial control. If the participant terminal detects a trigger operation for the confirmation control in the third prompt information, the meeting member designated to perform content sharing on the participant terminal waits. If the participant terminal detects a trigger operation for the denial control in the third prompt information, the participant terminal recalls the content sharing request initiated by the meeting member designated to perform content sharing.

In this embodiment, the participant terminal displays the third prompt information. The third prompt information is configured for indicating that the to-be-shared content carried in the content sharing request is waiting to be reviewed. If the to-be-shared content passes the review, the meeting member designated to perform content sharing is allowed to enter the waiting space. In this process, the host terminal determines a meeting member who enters the waiting space, and can reject entry of a meeting member who does not participate in the meeting or a meeting member who does not need to perform content sharing in the meeting to enter the waiting space. In this way, the content sharing efficiency is enhanced.

In an embodiment, the method further includes:
fourth prompt information is displayed in response to a removal instruction for the meeting member designated to perform content sharing, the fourth prompt information being configured for indicating that the meeting member designated to perform content sharing is removed from the waiting space; fifth prompt information is displayed in response to a disabling instruction for the waiting space, and displaying of the to-be-shared content is continued when the activation status of the meeting member designated to perform content sharing is the activated state, the fifth prompt being configured for indicating that the waiting space is disabled.

The removal instruction is generated by the host terminal according to a trigger operation for a removal control within a preset proximity range of the meeting member designated to perform content sharing on the meeting interface of the host terminal. For example, the host member triggers the removal control of the meeting member designated to perform content sharing on the meeting interface of the host terminal. After detecting a trigger operation for the removal control of the meeting member designated to perform content sharing, the host terminal generates, according to the trigger operation, the removal instruction for the meeting member designated to perform content sharing. The server forwards the removal instruction to the participant terminal used by the meeting member designated to perform content sharing.

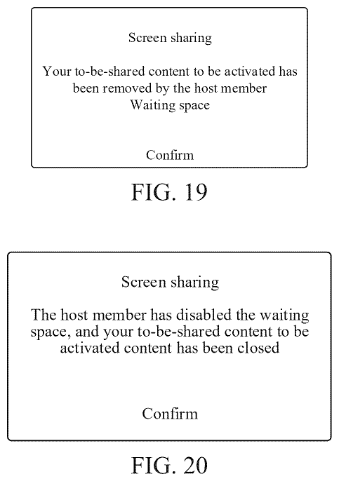

In some embodiments, the fourth prompt information includes prompt content and a close control. The close control is configured for closing the fourth prompt information. For example, FIG. 19 is a schematic diagram of fourth prompt information according to an embodiment. Prompt content of the fourth prompt information is “Your to-be-shared content to be activated has been removed from the waiting space by the host member”, and a corresponding close control is a “Confirm” control in FIG. 19. After the meeting member designated to perform content sharing on the participant terminal triggers the “Confirm” control in FIG. 19, the fourth prompt information is closed.

The disabling instruction is configured for instructing the server to disable the waiting space. The disabling instruction is generated according to a trigger operation of the host terminal for a waiting space disabling control. After the waiting space is disabled, the host terminal no longer displays the meeting members in the waiting space. For a meeting member whose activation status is the activated state, displaying of to-be-shared content in the content display area of the meeting of the host terminal is continued, and the fifth prompt information is displayed on meeting interfaces of participant terminals used by meeting member whose activation status is the to-be-activated state.

In some embodiments, the fifth prompt information includes prompt content and a close control. The close control is configured for closing the fifth prompt information. For example, FIG. 20 is a schematic diagram of fifth prompt information according to an embodiment. Activation status of a meeting member designated to perform content sharing on a participant terminal is a to-be-activated state, prompt content of the fifth prompt information is “The host member has disabled the waiting space, and your to-be-shared content to be activated is closed”, and a corresponding close control is a “Confirm” control in FIG. 20. After the meeting member designated to perform content sharing on the participant terminal triggers the “Confirm” control in FIG. 20, the fifth prompt information is closed.

In some embodiments, if the activation status of the meeting member designated to perform content sharing on the participant terminal is the activated state, the prompt content of the fifth prompt information may be “The host member has disabled the waiting space, your activated shared screen is not affected”.

Specifically, if a participant terminal receives a removal instruction for a meeting member designated to perform content sharing, in response to the removal instruction, the fourth prompt information is displayed on a meeting interface of the participant terminal. If the participant terminal receives a disabling instruction for a waiting space, and activation status of the meeting member designated to perform content sharing on the participant terminal is a to-be-activated state, the fifth prompt information is displayed on the meeting interface of the participant terminal. If the participant terminal receives the disabling instruction for the waiting space, and the activation status of the meeting member designated to perform content sharing on the participant terminal is an activated state, displaying of to-be-shared content in a content display area of a meeting of a host terminal is continued.

In this embodiment, after the host terminal removes the meeting member designated to perform content sharing on the participant terminal, the fourth prompt information is displayed. After the waiting space is disabled, the participant terminal displays the fifth prompt information. When the activation status of the meeting member designated to perform content sharing is the activated state, displaying of the to-be-shared content in the content display area is continued. In the foregoing process, even if the waiting space is disabled, the meeting member whose activation status is the activated state is not affected by disabling of the waiting space, and displaying of the to-be-shared content is continued. This avoids the problem that disabling of the waiting space causes the meeting member in the activated state to be closed, which reduces the content sharing efficiency.

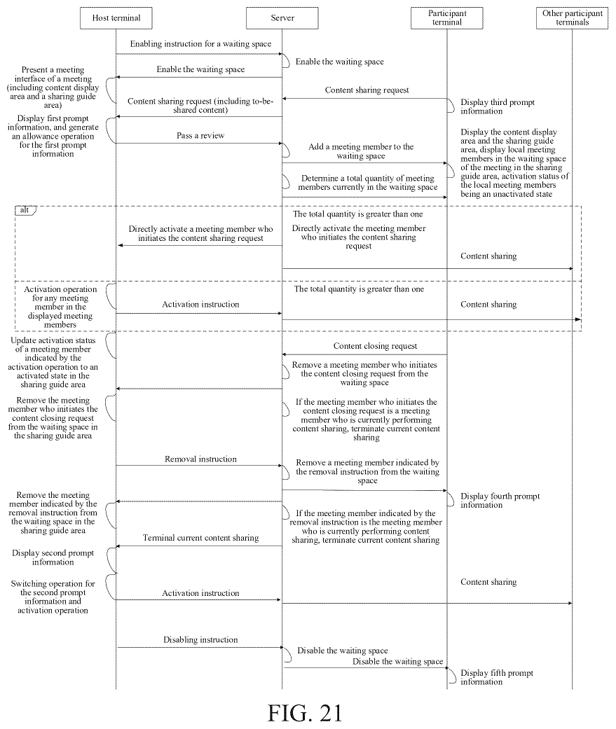

In a detailed embodiment, a content sharing method is provided. FIG. 21 is a diagram of a detailed time sequence of a content sharing method according to an embodiment. The method specifically includes the following operations:

I. A server receives an enabling instruction for a waiting space that is transmitted by a host terminal, and enables the waiting space in response to the enabling instruction.

II. A participant terminal initiates a content sharing request to the server in response to a content sharing operation triggered on a meeting interface.

III. The participant terminal displays third prompt information, the third prompt information being configured for indicating that to-be-shared content carried in the content sharing request is waiting to be reviewed.

IV. The server receives a content sharing request initiated by a meeting member participating in a meeting, and determines the meeting member who initiates the content sharing request as a meeting member designated to perform content sharing, the content sharing request including to-be-shared content.

V. The server forwards the content sharing request to the host terminal, to instruct the host terminal to review the to-be-shared content in the content sharing request.

VI. The host terminal displays first prompt information in response to the content sharing request initiated by the meeting member participating in the meeting; and the host terminal generates a review result indicating that the to-be-shared content passes the review according to an allowance operation for the first prompt information, and returns the review result to the server.

VII. When the to-be-shared content passes the review, the server adds the meeting member designated to perform content sharing to the waiting space.

VIII. When to-be-shared content passes the review, the participant terminal displays a sharing guide area on the meeting interface, and displays the meeting member designated to perform content sharing in the sharing guide area, activation status of the meeting member designated to perform content sharing is an inactivated state.

IX. The server determines a total quantity of meeting members currently in the waiting space; and directly transmits the to-be-shared content of the meeting member who initiates the content sharing request to participant terminals used by meeting members participating in the meeting if the total quantity is equal to one. If the total quantity is not equal to one, the server determines, in response to an activation instruction transmitted by the host terminal, any meeting member indicated by the activation instruction from the meeting members displayed by the host terminal, and transmits to-be-shared content of the meeting member indicated by the activation instruction to the participant terminals used by the meeting members participating in the meeting.

X. The host terminal displays the meeting members in the waiting space of the meeting and activation status of the meeting members in the sharing guide area, the activation status at least including a to-be-activated state and an activated state.

XI. The host terminal displays, in response to the activation operation for any to-be-activated meeting member, the to-be-shared content of the meeting member indicated by the activation operation in a content display area, and updates the activation status of the meeting member indicated by the activation operation to the activated state in the sharing guide area.

XII. When the server receives a content closing request initiated by the participant terminal, the server removes a meeting member who initiates the content closing request from the waiting space; and terminates current content sharing if the meeting member who initiates the content closing request is a meeting member who is currently performing content sharing.

XII. The host terminal removes the meeting member who initiates the content closing request from the waiting space in the sharing guide area.

XIII. The host terminal displays activation status of each meeting member within a preset proximity range of the meeting member, and displays a removal control within the preset proximity range of each to-be-activated meeting member, the removal control being configured for removing a meeting member from the waiting space.

XIV When the server receives a removal instruction transmitted by the host terminal for any meeting member in the displayed meeting members, the server removes, in response to the removal instruction, the meeting member indicated by the removal instruction from the waiting space; and terminates current content sharing if the meeting member indicated by the removal instruction is the meeting member who is currently performing content sharing.

XV The host terminal displays second prompt information when current content sharing is terminated, the second prompt information being configured for instructing to activate another to-be-activated meeting member; the host terminal detects, in response to a switching operation for the second prompt information, an activation operation for any to-be-activated meeting member in the waiting space, and performs switching to display to-be-shared content of the meeting member indicated by the activation operation when the activation operation is detected.

XVI. The participant terminal displays fourth prompt information in response to a removal instruction for the meeting member designated to perform content sharing, the fourth prompt information being configured for indicating that the meeting member designated to perform content sharing is removed from the waiting space.

XVII. When the server receives a disabling instruction for the waiting space transmitted by the host terminal, the server disables the waiting space in response to the disabling instruction; and closes to-be-shared content of a meeting member who is originally in a to-be-activated state in the waiting space, and remains a sharing operation for to-be-shared content of a meeting member who is originally in an activated state in the waiting space.

XVIII. The participant terminal displays fifth prompt information in response to the disabling instruction for the waiting space, and continues to display the to-be-shared content in the content display area when the activation status of the meeting member designated to perform content sharing is the activated state, the fifth prompt being configured for indicating that the waiting space is disabled.

In this embodiment, the server switches, according to the activation instruction of the host terminal, the meeting member who is performing content sharing. In the switching process, the meeting member who is performing content sharing does not need to stop sharing, the meeting member designated to perform content sharing does not need to enable sharing, and seamless switching of shared content in the meeting is achieved. In this way, a sharing operation process in the meeting is simplified, and the content sharing efficiency is enhanced.

Operations in flowcharts involved in the foregoing embodiments are shown sequentially based on indication of arrows, but the operations are not necessarily performed sequentially based on a sequence indicated by the arrows. Unless otherwise explicitly specified herein, an execution order of the operations is not strictly limited, and the operations may be executed in other orders. Moreover, at least some of the operations in the flowcharts involved in the foregoing embodiments may include a plurality of operations or a plurality of stages. These operations or stages are not necessarily performed at the same time, but may be performed at different times. These operations or stages are not necessarily performed in sequence, but may be performed in turn or in alternation with other operations or at least some of the operations or stages in other operations.

Based on the same inventive concept, the embodiments of this application further provide a content sharing apparatus configured to implement the foregoing content sharing method involved in the server. An implementation solution provided by the apparatus to address a problem is similar to the implementation solution described in the method. For specific limitations in one or more content sharing apparatus embodiments provided below, refer to the above limitations on the content sharing method. Details are not described here again.

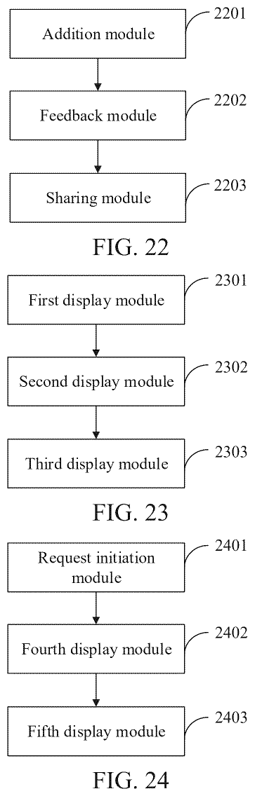

In an embodiment, as shown in FIG. 22, a content sharing apparatus is provided, which includes:
an addition module 2401, configured to determine, in response to a content sharing request initiated by a meeting member participating in a meeting, a meeting member designated to perform content sharing, and add the meeting member designated to perform content sharing to a waiting space;
a feedback module 2402, configured to return meeting members in the waiting space to a host terminal of the meeting, to instruct the host terminal to display the meeting members in the waiting space; and
a sharing module 2403, configured to determine, in response to an activation instruction transmitted by the host terminal, any meeting member indicated by the activation instruction from the meeting members displayed by the host terminal, and transmit to-be-shared content of the meeting member indicated by the activation instruction to participant terminals used by meeting members participating in the meeting.

In an embodiment, the addition module 2401 is further configured to enable the waiting space in response to an enabling instruction that is transmitted by the host terminal and that is configured for enabling the waiting space.

In an embodiment, the feedback module 2402 is further configured to receive the content sharing request initiated by the meeting member participating in the meeting, and determine the meeting member who initiates the content sharing request as the meeting member designated to perform content sharing, the content sharing request including to-be-shared content; and forward the content sharing request to the host terminal, to instruct the host terminal to review the to-be-shared content in the content sharing request; add the meeting member designated to perform content sharing to the waiting space when the to-be-shared content passes the review.

In an embodiment, the feedback module 2402 is further configured to determine a total quantity of meeting members currently in the waiting space; and directly transmit the to-be-shared content of the meeting member who initiates the content sharing request to the participant terminals used by the meeting members participating in the meeting if the total quantity is equal to one.

In an embodiment, the sharing module 2403 is further configured to remove a meeting member who initiates a content closing request from the waiting space when the content closing request is received; and terminate current content sharing if the meeting member who initiates the content closing request is a meeting member who is currently performing content sharing.

In an embodiment, the addition module 2401 is further configured to add a plurality of meeting members designated to perform content sharing to the waiting space; and sort the meeting members in the waiting space in a preset sorting manner.

In an embodiment, the addition module 2401 is further configured to terminate current content sharing if a content closing request initiated by the meeting member who is currently performing content sharing is received, and automatically transmit to-be-shared content of a next meeting member ranked after the meeting member who is currently performing content sharing to the participant terminals used by the meeting members participating in the meeting.

In an embodiment, the sharing module 2403 is further configured to determine, in response to a removal instruction transmitted by the host terminal, any meeting member indicated by the removal instruction from the meeting members displayed by the host terminal, and remove the meeting member indicated by the removal instruction from the waiting space; and terminate current content sharing if the meeting member indicated by the removal instruction is the meeting member who is currently performing content sharing.

In an embodiment, the sharing module 2403 is further configured to disable the waiting space in response to a disabling instruction transmitted by the host terminal; and close to-be-shared content of a meeting member who is originally in a to-be-activated state in the waiting space, and remain a sharing operation for to-be-shared content of a meeting member who is originally in an activated state in the waiting space.

Based on the same inventive concept, the embodiments of this application further provide a content sharing apparatus configured to implement the foregoing content sharing method involved in the host terminal. An implementation solution provided by the apparatus to address a problem is similar to the implementation solution described in the method. For specific limitations in one or more content sharing apparatus embodiments provided below, refer to the above limitations on the content sharing method. Details are not described here again.

In an embodiment, as shown in FIG. 23, a content sharing apparatus is provided, which includes:
a first display module 2301, configured to present a meeting interface of a meeting, the meeting interface including a content display area and a sharing guide area;
a second display module 2302, configured to display a meeting member designated to perform content sharing and activation status of meeting members in the sharing guide area, the activation status at least including a to-be-activated state and an activated state; and
a third display module 2303, configured to display, in response to an activation operation for any to-be-activated meeting member, to-be-shared content of the meeting member indicated by the activation operation in the content display area, and update the activation status of the meeting member indicated by the activation operation to an activated state in the sharing guide area.

In an embodiment, the second display module 2302 is further configured to display meeting members in a waiting space of the meeting in an itemized list in the sharing guide area, and display the activation status of each meeting member within a preset proximity range of the meeting member.

In an embodiment, the second display module 2302 is further configured to display the activation status of each meeting member within the preset proximity range of the meeting member, and display a removal control within the preset proximity range of each to-be-activated meeting member, the removal control being configured for removing a meeting member from the waiting space.

In an embodiment, the second display module 2302 is further configured to display respective corresponding to-be-shared content within the preset proximity range of each to-be-activated meeting member.

In an embodiment, the third display module 2303 is further configured to display first prompt information in response to a content sharing request initiated by a meeting member participating in the meeting; and add, in response to an allowance operation for the first prompt information, the meeting member who initiates the content sharing request to the sharing guide area for displaying.

In an embodiment, the third display module 2303 is further configured to display second prompt information when current content sharing is terminated, the second prompt information being configured for instructing to activate another to-be-activated meeting member; detect, in response to a switching operation for the second prompt information, an activation operation for any to-be-activated meeting member in the waiting space, and perform switching to display to-be-shared content of the meeting member indicated by the activation operation when the activation operation is detected.

Based on the same inventive concept, the embodiments of this application further provide a content sharing apparatus configured to implement the foregoing content sharing method involved in the participant terminal. An implementation solution provided by the apparatus to address a problem is similar to the implementation solution described in the method. For specific limitations in one or more content sharing apparatus embodiments provided below, refer to the above limitations on the content sharing method. Details are not described here again.

In an embodiment, as shown in FIG. 24, a content sharing apparatus is provided, which includes:
a request initiation module 2401, configured to initiate a content sharing request in response to a content sharing operation triggered on a meeting interface;
a fourth display module 2402, configured to display a sharing guide area on the meeting interface, and display a meeting member designated to perform content sharing in a waiting space of the meeting in the sharing guide area, activation status of the meeting member designated to perform content sharing being an inactivated state; and
a fifth display module 2403, configured to update, in response to an activation instruction for the meeting member designated to perform content sharing, the activation status of the meeting member designated to perform content sharing to an activated state in the sharing guide area, and share to-be-shared content corresponding to the content sharing request.

In an embodiment, the fourth display module 2402 is further configured to display third prompt information, the third prompt information being configured for indicating that the to-be-shared content carried in the content sharing request is waiting to be reviewed; and allow addition of the meeting member designated to perform content sharing to a waiting space when the to-be-shared content passes the review.

In an embodiment, the fifth display module 2403 is further configured to display fourth prompt information in response to a removal instruction for the meeting member designated to perform content sharing, the fourth prompt information being configured for indicating that the meeting member designated to perform content sharing is removed from the waiting space; display fifth prompt information in response to a disabling instruction for the waiting space, and continue to display the to-be-shared content in the content display area when the activation status of the meeting member designated to perform content sharing is the activated state, the fifth prompt information being configured for indicating that the waiting space is disabled.

The modules in the foregoing content sharing apparatus may be partially or completely implemented through software, hardware, or a combination thereof. The modules may be embedded in or independent of a processor in a computer device in a form of hardware, or may be stored in a memory in a computer device in a form of software, which is invoked by a processor to perform operations corresponding to the modules.

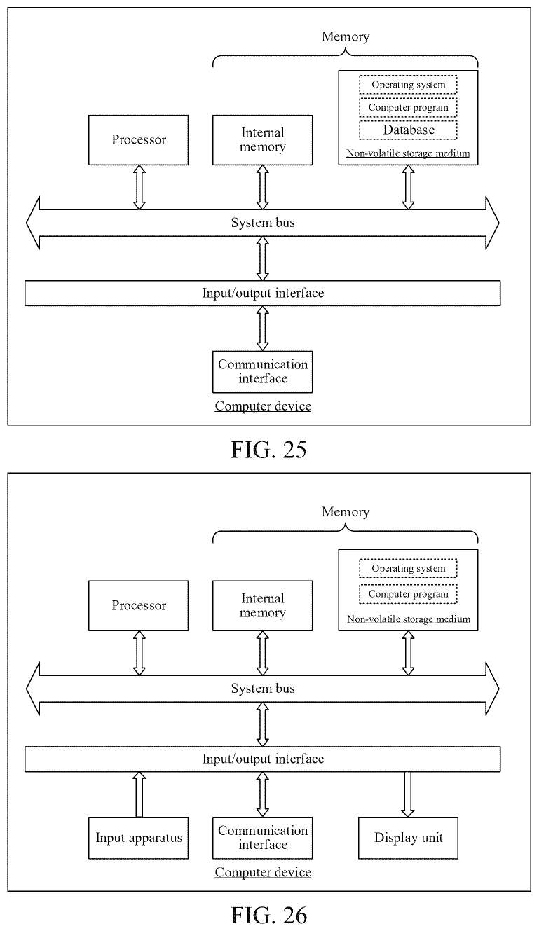

In an embodiment, a computer device is provided. The computer device may be a server. A diagram of an internal structure of the computer device may be shown in FIG. 25. The computer device includes a processor, a memory, an input/output (I/O) interface, and a communication interface. The processor, the memory, and the I/O interface are connected via a system bus, and the communication interface is connected to the system bus via the I/O interface. The processor of the computer device is configured to provide computing and control capabilities. The memory of the computer device includes a non-volatile storage medium and an internal memory. The non-volatile storage medium has an operating system, a computer program, and a database stored therein. The internal memory provides an environment for running of the operating system and the computer program in the non-volatile storage medium. The database of the computer device is configured for storing to-be-shared content. The I/O interface of the computer device is configured to exchange information between the processor and an external device. The communication interface of the computer device is configured to connect to and communicate with an external terminal over a network. The computer program, when executed by the processor, implements one content sharing method.

In an embodiment, a computer device is provided. The computer device may be a terminal. A diagram of an internal structure the computer device may be shown in FIG. 26. The computer device includes a processor, a memory, an I/O interface, a communication interface, a display unit, and an input apparatus. The processor, the memory, and the I/O interface are connected via a system bus, and the communication interface, the display unit, and the input apparatus are connected to the system bus via the I/O interface. The processor of the computer device is configured to provide computing and control capabilities. The memory of the computer device includes a non-volatile storage medium and an internal memory. The non-volatile storage medium has an operating system and a computer program stored therein. The internal memory provides an environment for running of the operating system and the computer program in the non-volatile storage medium. The I/O interface of the computer device is configured to exchange information between the processor and an external device. The communication interface of the computer device is configured to communicate with an external terminal by using a wired or wireless communication protocol. The wireless communication protocol may be implemented through Wireless Fidelity (Wi-Fi), a mobile cellular network, near-field communication (NFC), or another technology. The computer program, when executed by the processor, implements one content sharing method. The display unit of the computer device is configured to form a visually visible picture, and may be a display screen, a projection apparatus, or a virtual reality imaging apparatus. The display screen may be a liquid crystal display screen or an electronic-ink display screen. The input apparatus of the computer device may be a touch layer covering the display screen, or may be a key, trackball, or touchpad disposed on a housing of the computer device, or may be an external keyboard, touchpad, mouse, or the like.

A person skilled in the art appreciates that the structures shown in FIG. 25 and FIG. 26 are merely block diagrams of partial structures related to the solution of this application, and are not intended to be constructed as limitations on the computer device to which the solution of this application is applied. Specifically, the computer device may include more or fewer components than those shown in the figure, or some components may be combined, or a different component deployment may be adopted.

In an embodiment, a computer device is provided, which includes a memory and a processor. The memory has a computer program stored therein. The processor implements the operations in the foregoing method embodiments when executing the computer program.

In an embodiment, a computer-readable storage medium is provided, which has a computer program stored therein. The computer program, when executed by a processor, implements the operations in the foregoing method embodiments.

In an embodiment, a computer program product is provided, which includes a computer program. The computer program, when executed by a processor, implements the operations in the foregoing method embodiments.

User information (including but not limited to user device information, user personal information, and the like) and data (including but not limited to data for analysis, stored data, displayed data, and the like) involved in this application both are information and data that are authorized by users or fully authorized by all parties. Collection, use, and processing of related data need to comply with relevant regulations.

A person of ordinary skill in the art appreciates that all or some of the processes in the method according to the foregoing embodiments may be implemented by a computer program instructing relevant hardware. The computer program may be stored in one non-volatile computer-readable storage medium. When the computer program is executed, processes in the foregoing method embodiments may be implemented. Any reference to the memory, database, or another medium used in the embodiments provided by this application may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random-access memory (ReRAM), a magnetoresistive random-access memory (MRAM), a ferroelectric random-access memory (FRAM), a phase-change memory (PCM), a graphene memory, and the like. The volatile memory may include a random-access memory (RAM) or an external cache memory. For the purpose of illustration rather than limitation, the RAM may be in various forms, such as a static random-access memory (SRAM), or a dynamic random-access memory (DRAM). The database involved in the embodiments provided in this application may include at least one of a relational database and a non-relational database. The non-relational database may include, but is not limited to, a distributed database based on a blockchain. The processor involved in the embodiments provided in this application may be, but is not limited to, a general-purpose processor, a central processing unit, a graphics processing unit, a digital signal processor, a programmable logic device, a data processing logic device based on quantum computing, or the like.

Technical features of the foregoing embodiments may be combined in different manner to form other embodiments. To simplify description, all possible combinations of the technical features in the foregoing embodiments are not described. However, the combinations of these technical features fall within the scope of this description, provided that no contradiction exists in the combinations.

The embodiments described above are merely several implementations of this application, and are specifically described in detail, but cannot be interpreted as limiting the scope of the patent of this application as a result. A person of ordinary skill in the art may make several transformations and improvements without departing from the concept of this application, and these transformations and improvements all fall within the scope of protection of this application. Therefore, the scope of protection of the patent of this application is subject to the appended claims.

What is claimed is:

1. A method for sharing content in an online meeting performed by a computer device, the method comprising:
in response to a content sharing request initiated by a meeting member participating in an online meeting, adding the meeting member designated to perform content sharing to a waiting space;
forwarding the content sharing request to a host terminal of the meeting wherein the host terminal is configured to determine whether or not to grant the content sharing request; and
in response to an activation instruction transmitted by the host terminal, determining, among meeting members in the waiting space, a meeting member indicated by the activation instruction, and transmitting to-be-shared content of the meeting member indicated by the activation instruction to participant terminals used by other meeting members participating in the meeting.

2. The method according to claim 1, wherein the adding the meeting member designated to perform content sharing to a waiting space comprises:
after receiving the content sharing request initiated by the meeting member participating in the meeting, determining the meeting member who initiates the content sharing request as the meeting member designated to perform content sharing, the content sharing request comprising to-be-shared content; and
adding the meeting member designated to perform content sharing to the waiting space when the to-be-shared content passes a review by the host terminal.

3. The method according to claim 1, wherein the method further comprises:
determining a total quantity of meeting members currently in the waiting space after the meeting member designated to perform content sharing is added to the waiting space; and
directly transmitting to-be-shared content of the meeting member who initiates the content sharing request to the participant terminals used by the meeting members participating in the meeting if the total quantity is equal to one.

4. The method according to claim 1, wherein the method further comprises:
removing a meeting member who initiates a content closing request from the waiting space after the content closing request is received; and
terminating current content sharing by the meeting member who initiates the content closing request.

5. The method according to claim 1, wherein in a case of receiving a plurality of content sharing requests, the adding the meeting member designated to perform content sharing to a waiting space comprises:
adding a plurality of meeting members corresponding to the plurality of content sharing requests as being designated to perform content sharing to the waiting space; and
sorting the meeting members in the waiting space in a preset sorting manner.

6. The method according to claim 5, wherein the method further comprises:
terminating current content sharing when a content closing request initiated by the meeting member who is currently performing content sharing is received, and automatically transmitting to-be-shared content of a next meeting member ranked after the meeting member who is currently performing content sharing to the participant terminals used by the meeting members participating in the meeting.

7. The method according to claim 1, wherein the method further comprises:
in response to a removal instruction transmitted by the host terminal, removing a meeting member indicated by the removal instruction from the waiting space; and
terminating current content sharing by the meeting member indicated by the removal instruction.

8. A computer device, comprising a memory and a processor, the memory having a computer program stored therein, and the processor, when executing the computer program, causing the computer device to implement a method for sharing content in an online meeting including:
in response to a content sharing request initiated by a meeting member participating in an online meeting, adding the meeting member designated to perform content sharing to a waiting space;
forwarding the content sharing request to a host terminal of the meeting wherein the host terminal is configured to determine whether or not to grant the content sharing request; and
in response to an activation instruction transmitted by the host terminal, determining, among meeting members in the waiting space, a meeting member indicated by the activation instruction, and transmitting to-be-shared content of the meeting member indicated by the activation instruction to participant terminals used by other meeting members participating in the meeting.

9. The computer device according to claim 8, wherein the adding the meeting member designated to perform content sharing to a waiting space comprises:
after receiving the content sharing request initiated by the meeting member participating in the meeting, determining the meeting member who initiates the content sharing request as the meeting member designated to perform content sharing, the content sharing request comprising to-be-shared content; and
adding the meeting member designated to perform content sharing to the waiting space when the to-be-shared content passes a review by the host terminal.

10. The computer device according to claim 8, wherein the method further comprises:
determining a total quantity of meeting members currently in the waiting space after the meeting member designated to perform content sharing is added to the waiting space; and
directly transmitting to-be-shared content of the meeting member who initiates the content sharing request to the participant terminals used by the meeting members participating in the meeting if the total quantity is equal to one.

11. The computer device according to claim 8, wherein the method further comprises:
removing a meeting member who initiates a content closing request from the waiting space after the content closing request is received; and
terminating current content sharing by the meeting member who initiates the content closing request.

12. The computer device according to claim 8, wherein in a case of receiving a plurality of content sharing requests, the adding the meeting member designated to perform content sharing to a waiting space comprises:
adding a plurality of meeting members corresponding to the plurality of content sharing requests as being designated to perform content sharing to the waiting space; and
sorting the meeting members in the waiting space in a preset sorting manner.

13. The computer device according to claim 12, wherein the method further comprises:
terminating current content sharing when a content closing request initiated by the meeting member who is currently performing content sharing is received, and automatically transmitting to-be-shared content of a next meeting member ranked after the meeting member who is currently performing content sharing to the participant terminals used by the meeting members participating in the meeting.

14. The computer device according to claim 8, wherein the method further comprises:
in response to a removal instruction transmitted by the host terminal, removing a meeting member indicated by the removal instruction from the waiting space; and
terminating current content sharing by the meeting member indicated by the removal instruction.

15. A non-transitory computer-readable storage medium, having a computer program stored therein, the computer program, when executed by a processor of a computer device, causing the computer device to implement a method for sharing content in an online meeting including:
in response to a content sharing request initiated by a meeting member participating in an online meeting, adding the meeting member designated to perform content sharing to a waiting space;
forwarding the content sharing request to a host terminal of the meeting wherein the host terminal is configured to determine whether or not to grant the content sharing request; and
in response to an activation instruction transmitted by the host terminal, determining, among meeting members in the waiting space, a meeting member indicated by the activation instruction, and transmitting to-be-shared content of the meeting member indicated by the activation instruction to participant terminals used by other meeting members participating in the meeting.

16. The non-transitory computer-readable storage medium according to claim 15, wherein the adding the meeting member designated to perform content sharing to a waiting space comprises:
after receiving the content sharing request initiated by the meeting member participating in the meeting, determining the meeting member who initiates the content sharing request as the meeting member designated to perform content sharing, the content sharing request comprising to-be-shared content; and
adding the meeting member designated to perform content sharing to the waiting space when the to-be-shared content passes a review by the host terminal.

17. The non-transitory computer-readable storage medium according to claim 15, wherein the method further comprises:
determining a total quantity of meeting members currently in the waiting space after the meeting member designated to perform content sharing is added to the waiting space; and
directly transmitting to-be-shared content of the meeting member who initiates the content sharing request to the participant terminals used by the meeting members participating in the meeting if the total quantity is equal to one.

18. The non-transitory computer-readable storage medium according to claim 15, wherein the method further comprises:
removing a meeting member who initiates a content closing request from the waiting space after the content closing request is received; and
terminating current content sharing by the meeting member who initiates the content closing request.

19. The non-transitory computer-readable storage medium according to claim 15, wherein in a case of receiving a plurality of content sharing requests, the adding the meeting member designated to perform content sharing to a waiting space comprises:
adding a plurality of meeting members corresponding to the plurality of content sharing requests as being designated to perform content sharing to the waiting space; and
sorting the meeting members in the waiting space in a preset sorting manner.

20. The non-transitory computer-readable storage medium according to claim 15, wherein the method further comprises:
in response to a removal instruction transmitted by the host terminal, removing a meeting member indicated by the removal instruction from the waiting space; and
terminating current content sharing by the meeting member indicated by the removal instruction.
